(19) United States
(12) Patent Application Publication
(10) Pub. No.: US 2016/0196782 A1
(43) Pub. Date: Jul. 7, 2016

(54) FLEXIBLE DISPLAY DEVICE

(71) Applicant: Samsung Display Co., Ltd., Yongin-si (KR)

(72) Inventors: Lu Ly LEE, Yongin-si (KR); Dong Hyeon LEE, Seoul (KR); Jae Sang LEE, Asan-si (KR)

(21) Appl. No.: 14/874,255

(22) Filed: Oct. 2, 2015

(30) Foreign Application Priority Data
Jan. 7, 2015 (KR) 10-2015-0002204

(51) Int. Cl. G09G 3/32

(52) U.S. Cl. CPC G09G 3/32; G09G 2380/02; G09G 2300/04; G09G 2300/0452; G09G 2320/0233

(57) ABSTRACT

Disclosed herein is a curved display device, the curved display device according to an exemplary embodiment of the present invention including: a curved display panel including a curved surface, the curved display panel having a first curved side and a second curved side facing each other and a first straight side and a second straight side facing each other, a plurality of pixels, a plurality of gate lines, and a plurality of data lines; first gate drivers connected to the plurality of gate lines; first data drivers positioned at the first straight side and connected to the plurality of data lines; a first printed circuit board connected to the first data driver; and a first signal controller connected to the first printed circuit board.

### CROSS-REFERENCE TO RELATED APPLICATION

This application claims priority to, and the benefit of, Korean Patent Application No. 10-2015-0002204 filed in the Korean Intellectual Property Office on Jan. 7, 2015, the entire contents of which are incorporated herein by reference.

### BACKGROUND

(a) Field

Embodiment of the present invention relate generally to flat panel displays. More specifically, embodiments of the present invention relate to flexible flat panel display devices.

(b) Description of the Related Art

A flat panel display, such as a liquid crystal display (LCD) or an organic light emitting diode (OLED) display, has a display unit, which is configured of a plurality pixels, that controls the on/off and luminance state of each pixel, thereby projecting a predetermined image. traditional flat panel displays have employed glass substrates. Recently though, flat panel displays have at times begun using a flexible material such as plastic for their substrates, and as a result, a flexible display device which may be bent and folded has been developed.

The flexible display device may be widely applied to small electronic devices such as mobile devices, and to large home appliances such as televisions. In the latter case, the flexible display device may provide a screen in a curved form to provide a three-dimensional effect and greater immersion to a user. For example, a flexible display device may be bent into a concave shape which, when viewed by a user, projects images across the entire viewing angle of the user with reduced image distortion due to the viewing angle, as compared with a flat display device.

The curved display device includes data drivers in a chip on film (COF) form which are disposed at a long side of the display panel having a preset curvature. The display device also includes a printed circuit board connected to the data drivers, and a signal controller controlling the printed circuit board.

Unfortunately, when a radius of curvature of this long side is reduced, a degree of curvature of the printed circuit board is increased, and a degree of warping of the data drivers (which are positioned at both ends of the printed circuit board and connected to the display panel) is thus increased, such that the data driver may be damaged or the display panel may become cracked.

To mitigate stress of the data driver in the chip on film form, a method for dividing the printed circuit board into several parts and increasing the number of data drivers has been utilized. However, this method suffers from the drawback that the number of screw points for fastening between a top chassis and a bottom chassis is reduced, and therefore a fastening force between the top chassis and the bottom chassis may be weakened and the curvature of the display panel may be more difficult to maintain.

The above information disclosed in this Background section is only for enhancement of understanding of the background of the invention and therefore it may contain information that does not form the prior art that is already known in this country to a person of ordinary skill in the art.

### SUMMARY

Embodiments of the present invention provide a curved display device having the advantage of preventing data drivers from being damaged, by forming the data drivers at one side of a curved display panel having substantially no curvature, or insufficient curvature to result in damage to the data drivers.

Further, embodiments of the present invention provide a curved display device having the advantage of maintaining a curvature of a curved display panel by accommodating the curved display panel in a bottom chassis and forming a protective structure on a back surface of the bottom chassis.

In addition, exemplary embodiments of the present invention may realize further advantages which will be apparent to one of ordinary skill in the art.

An exemplary embodiment of the present invention provides a curved display device including: a curved display panel including a curved surface, the curved display panel having a first curved side and a second curved side facing each other and a first straight side and a second straight side facing each other, a plurality of pixels, a plurality of gate lines, and a plurality of data lines; first gate drivers connected to the plurality of gate lines; first data drivers positioned at the first straight side and connected to the plurality of data lines; a first printed circuit board connected to the first data driver; and a first signal controller connected to the first printed circuit board.

The curved display device may further include: second data drivers positioned at the second straight side and connected to the plurality of data lines; and a second printed circuit board connected to the second data driver.

The curved display device may further include multiple ones of at least one of the first printed circuit board and the second printed circuit board.

The first data driver may be a chip on film driver.

The first gate driver may be positioned proximate to the first curved side.

The curved display device may further include second gate drivers positioned at the second curved side and connected to the plurality of gate lines.

The first gate drivers may be mounted on the curved display panel.

The curved display device may further include second gate drivers positioned proximate to the first or second curved side and connected to the plurality of gate lines.

The first gate driver may be positioned proximate to the second side.

The curved display device may further include a bottom chassis in which the curved display panel is accommodated and a protective structure positioned on a back surface of the bottom chassis and at least partially enclosing the first data driver, the first printed circuit board, and the first signal controller.

The second printed circuit board may be connected to the first signal controller.

The curved display device may further include a bottom chassis in which the curved display panel is accommodated and a protective structure positioned on a back surface of the bottom chassis and at least partially enclosing the first data driver, the second data driver, the first printed circuit board, the second printed circuit board, and the first signal controller.

The curved display device may further include a second signal controller connected to the second printed circuit board.

The curved display device may further include a bottom chassis in which the curved display panel is accommodated and a protective structure positioned on a back surface of the bottom chassis and at least partially enclosing the first data driver, the second data driver, the first printed circuit board, the second printed circuit board, the first signal controller, and the second signal controller.

According to an exemplary embodiment of the present invention, it is possible to prevent the chip on film and the driving chip from being damaged due to the curvature of the display panel in the curved display device. Further, it is possible to improve the reliability and durability of the display device by maintaining the curvature of the display panel and securing the stiffness thereof.

### BRIEF DESCRIPTION OF THE DRAWINGS

FIG. 1 is an exploded plan view of a curved display device according to a first exemplary embodiment of the present invention.

FIG. 2 is a cross-sectional view of the curved display device taken along the line A-A′ of FIG. 1, with certain components positioned along the back surface of the display device instead of being in exploded configuration.

FIG. 3 is an exploded plan view of a curved display device according to a second exemplary embodiment of the present invention.

FIG. 4 is a cross-sectional view of the curved display device taken along the line B-B′ of FIG. 3, with certain components positioned along the back surface of the display device instead of being in exploded configuration.

FIG. 5 is the curved display device of FIG. 1 having a bottom chassis and a structure formed on a back surface thereof.

FIG. 6 is the curved display device of FIG. 3 having a bottom chassis and a structure formed on a back surface thereof.

### DETAILED DESCRIPTION OF THE EMBODIMENTS

Hereinafter, exemplary embodiments of the present invention so as to be easily practiced by a person skilled in the art to which the present invention pertains will be described in detail with reference to the accompanying drawings. As those skilled in the art would realize, the described embodiments may be modified in various different ways, all without departing from the spirit or scope of the present invention. In order to clearly describe the present invention, portions that are not connected with the description will be omitted. Like reference numerals designate like elements throughout the specification. In addition, the detailed description of widely known technologies will be omitted.

Throughout the present specification, it will be understood that when an element such as a layer, a film, a region, or a substrate is referred to as being “on” another element, it may be directly on another element or may have an intervening element present therebetween. Further, “˜on” means that an element is over or under an object portion and does not mean that an element is necessarily positioned over an upper portion based on a gravity direction.

Throughout the present specification, unless explicitly described to the contrary, “comprising” any components will be understood to imply the inclusion of other elements. A size, a thickness, etc., of each component illustrated in the drawings are arbitrarily illustrated for convenience of explanation and therefore the present invention is not just limited thereto. The various Figures are thus not to scale. Also, all numerical values are approximate, and may vary.

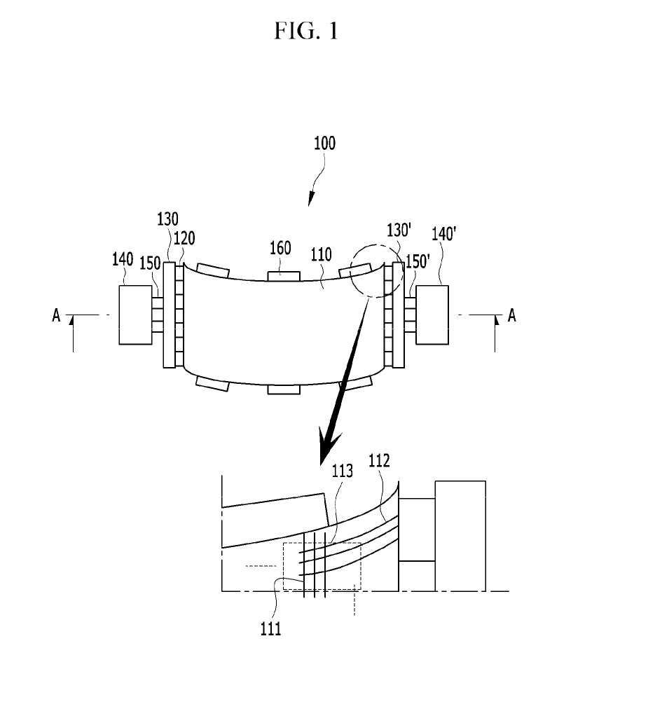

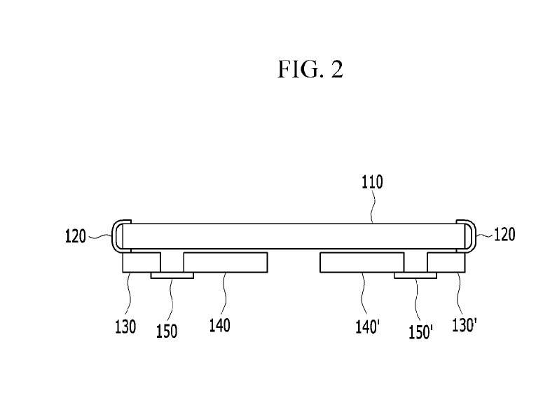

FIG. 1 is an exploded plan view of a curved display device according to a first exemplary embodiment of the present invention and FIG. 2 is a cross-sectional view of the curved display device taken along the line A-A′ of FIG. 1, with components 130, 130′, 140, 140′, 150, and 150′ positioned along the back surface of panel 110 rather than in exploded configuration.

Referring to FIGS. 1 and 2, a curved display device 100 according to the first exemplary embodiment of the present invention includes a curved display panel 110, at least one data driver 120, printed circuit boards (PCBs) 130 and 130′, signal controllers 140 and 140′, and at least one gate driver 160.

The curved display panel 110 outputs an image and includes a first curved side and a second curved side which face each other (here, the top and bottom sides of panel 110), as well as a first side and a second side which are substantially straight sides that face each other (the left and right sides of panel 110). In the embodiment shown, and as a nonlimiting example, the first curved side and the second curved side are bent so as to each have a preset curvature, and thus to have a predetermined concave shape.

The curved display panel 110 includes a plurality of gate lines 111, a plurality of data lines 112, and a plurality of pixels 113.

The curved display panel 110 may be formed of flexible, thin glass or may be formed of a plastic film which is made of, for example, polyimide, polyethylene terephthalate, polycarbonate, polyethylene naphthalate, polyarylate, and/or polyether imide.

The data driver 120 is connected to a plurality of data lines 112 to transfer electric signals and may be formed at a first side, a second side, or the first side and the second side, of the curved display panel 110.

The data driver 120 transfers data signals from the first printed circuit board (PCB) 130 to the plurality of data lines 112, and may be fabricated in a chip on film (COF) form. Further, the data driver 120 may transfer the data signal from the second printed circuit board (PCB) 130′ to the plurality of data lines.

The data drivers 120 may be formed at the first side, the second side, or the first side and the second side, of the curved display panel 110 at preset intervals. That is, the data drivers 120 are placed at the straight sides, rather than the curved sides, of the display panel 110. The data drivers 120 may be placed at any one or more of the substantially straight sides of the display panel 110.

The first printed circuit board (PCB) 130 generates the data signals based on driving signals output from the first signal controller 140, and transfers the generated data signals to the plurality of data drivers 120.

The second printed circuit board (PCB) 130′ generates the data signals based on driving signals output from the second signal controller 140′ and transfers the generated data signals to the plurality of data drivers 120.

FIGS. 1 and 2 illustrate one first printed circuit board (PCB) 130 and one second printed circuit board 130′ which are connected to the plurality of data drivers 120, but the embodiments of the present invention are not limited thereto. Therefore, more than one first printed circuit board and/or more than one second printed circuit board may be provided.

The first printed circuit board 130 and the second printed circuit board 130′ may have flexibility similar to the curved display panel 110.

The first signal controller 140 is connected to the first printed circuit board 130, receives an image signal from an external source, and outputs a control signal for displaying the image signal. In this case, the first printed circuit board 130 and the first signal controller 140 are connected to each other through a flexible cable, for example, a flexible flat cable (FFC).

The second signal controller 140′ is connected to the second printed circuit board 130′, receives the image signal from an external source, and outputs the control signal for displaying the image signal. In this case, the second printed circuit board 130′ and the second signal controller 140′ are also connected to each other through a flexible cable, for example, an FFC.

The gate driver 160 is connected to a plurality of gate lines 111 to transfer gate signals and may be formed at either one or both of the curved sides of the curved display panel 110.

The gate driver 160 may be mounted within or on the curved display panel 110. As a result, the curved display panel may be made relatively thin, and the number of parts and processes may be reduced to save manufacturing cost.

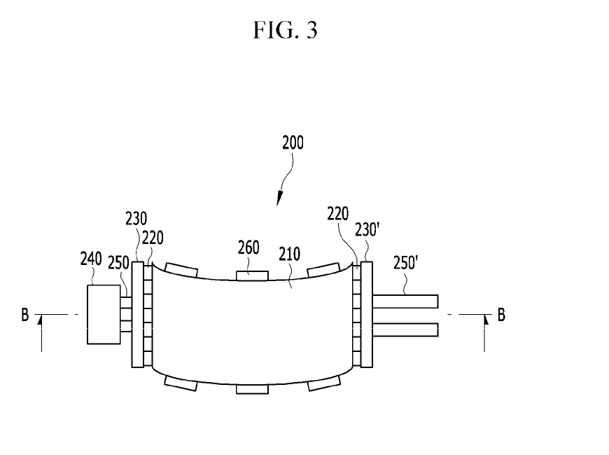

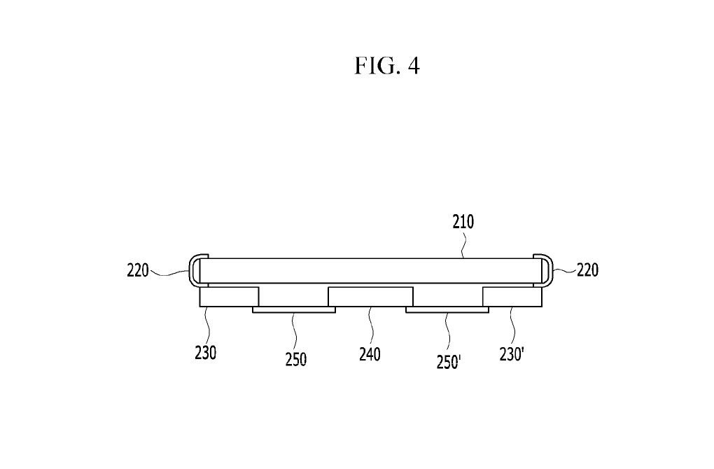

FIG. 3 is an exploded plan view of a curved display device according to a second exemplary embodiment of the present invention and FIG. 4 is a cross-sectional view of the curved display device taken along the line B-B′ of FIG. 3, with components 230, 230′, 240, 250, and 250′ positioned along the back surface of panel 210 rather than in exploded configuration.

Referring to FIGS. 3 and 4, a curved display device 200 according to the second exemplary embodiment of the present invention includes a curved display panel 210, at least one data driver 220, printed circuit boards (PCBs) 230 and 230′, a signal controller 240, and at least one gate driver 260.

In the curved display device 200 of FIGS. 3 and 4, one terminal of the signal controller 240 is connected to the first printed circuit board 230 through a first cable 250 and the other terminal thereof is connected to the second printed circuit board 230′ through a second cable 250′.

According to the curved display device of FIGS. 1 to 4, a plurality of data drivers is formed at a first side, a second side, or the first side and the second side of the curved display panel to prevent a driving chip from being damaged or the printed circuit board from cracking due to warpage of the curved display panel, and to improve durability and reliability of the display device.

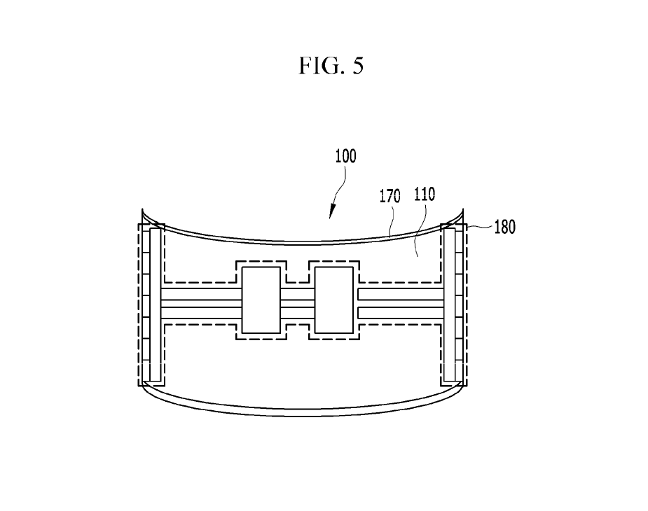

FIG. 5 shows the curved display device of FIG. 1 with an additional bottom chassis and a protective structure formed on a back surface thereof.

Referring to FIG. 5, the display panel 110 of FIG. 1 is accommodated in the bottom chassis 170 and a protective structure 180 is formed on a back surface of the bottom chassis 170. The structure 180 may be configured to enclose the data drivers 120.

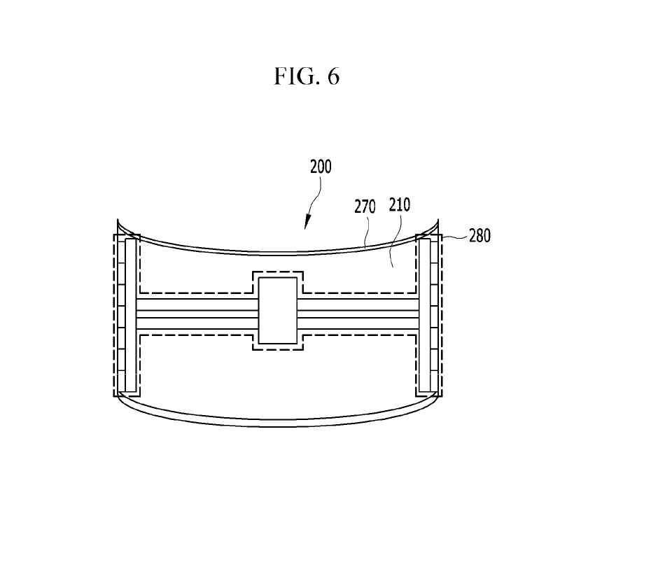

FIG. 6 shows the curved display device of FIG. 3 with an additional bottom chassis and a protective structure formed on a back surface thereof.

Referring to FIG. 6, the curved display panel 210 of FIG. 3 is accommodated in the bottom chassis 270 and a protective structure 280 is formed on a back surface of the bottom chassis 270. The structure 280 may be configured to enclose the data drivers 220.

The structures 180 and 280 of FIGS. 5 and 6 may be made of a metal such as stainless steel, aluminum, and magnesium, and/or any other rigid, stiff materials, such as rigid plastics (e.g., rigid polyvinyl chloride (PVC)) or the like.

The structures 180 and 280 of FIGS. 5 and 6 may protect the data drivers 120 and 220 and support left and right short sides of the display panels 110 and 210 to maintain the curvatures of the display panels 110 and 210 and improve the stiffness thereof. Further, functions of the existing shield case, control board cover, and curvature keeping bracket are implemented by the protective structures 180 and 280 of FIGS. 5 and 6 to increase the number of screw points for fastening between the top chassis and the bottom chassis which are positioned at the first curved side, the second curved side, and the first side or the second side of the display device, thereby improving the fastening force between the top chassis and the bottom chassis.

The protective structures 180, 280 can take on any shapes so long as they both stiffen the left- and right-side edges of the display device, and substantially enclose or otherwise protect the data drivers 120, 220. In one nonlimiting example, the protective structures 180, 280 may each be a unitary, continuous structure with edge portions that wrap around each side edge of the display device to cover the corresponding data driver 120/220, and that also has a central portion extending between the edge portions to at least partially cover the corresponding cables 150, 150′/250, 250′ and signal controller(s) 140, 240.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. Furthermore, different features of the various embodiments, disclosed or otherwise understood, can be mixed and matched in any manner to produce further embodiments within the scope of the invention.

### DESCRIPTION OF SYMBOLS

100, 200 : Curved display device
110, 120 : Curved display panel
111 : Gateline
112 : Dataline
113: Pixel
120,220 : Data driver
130, 230: First printed circuit board
130′, 230′: Second printed circuit board
140: First signal controller
140′: Second signal controller
240 : Signal controller
150, 250: First cable
150′, 250′: Second cable
160, 260 : Gate driver
170, 270: Bottom chassis
180, 280: Fixation

What is claimed is:

1. A curved display device, comprising:
a curved display panel including a curved surface, the curved display panel having a first curved side and a second curved side facing each other, and a first straight side and a second straight side facing each other, a plurality of pixels, a plurality of gate lines, and a plurality of data lines;
first gate drivers connected to the plurality of gate lines;
first data drivers positioned at the first straight side and connected to the plurality of data lines;
a first printed circuit board connected to the first data driver; and
a first signal controller connected to the first printed circuit board.

2. The curved display device of claim 1, further comprising:
second data drivers positioned at the second straight side and connected to the plurality of data lines; and
a second printed circuit board connected to the second data driver.

3. The curved display device of claim 2, further comprising multiple ones of at least one of the first printed circuit board and the second printed circuit board.

4. The curved display device of claim 1, wherein:
the first data drivers are chip on film drivers.

5. The curved display device of claim 1, wherein:
the first gate drivers are positioned proximate to the first curved side.

6. The curved display device of claim 5, further comprising:
second gate drivers positioned at the second curved side and connected to the plurality of gate lines.

7. The curved display device of claim 1, wherein:
the first gate drivers are mounted on the curved display panel.

8. The curved display device of claim 7, further comprising:
second gate drivers positioned proximate to the first or second curved side and connected to the plurality of gate lines.

9. The curved display device of claim 1, wherein:
the first gate driver is positioned proximate to the second side.

10. The curved display device of claim 1, further comprising:
a bottom chassis in which the curved display panel is accommodated and a protective structure positioned on a back surface of the bottom chassis and at least partially enclosing the first data driver, the first printed circuit board, and the first signal controller.

11. The curved display device of claim 2, wherein:
the second printed circuit board is connected to the first signal controller.

12. The curved display device of claim 11, further comprising:
a bottom chassis in which the curved display panel is accommodated and a protective structure positioned on a back surface of the bottom chassis and at least partially enclosing the first data driver, the second data driver, the first printed circuit board, the second printed circuit board, and the first signal controller.

13. The curved display device of claim 2, further comprising:
a second signal controller connected to the second printed circuit board.

14. The curved display device of claim 13, further comprising:
a bottom chassis in which the curved display panel is accommodated and a protective structure positioned on a back surface of the bottom chassis and at least partially enclosing the first data driver, the second data driver, the first printed circuit board, the second printed circuit board, the first signal controller, and the second signal controller.
